(19) United States
(12) Patent Application Publication
(10) Pub. No.: US 2005/0015297 A1
(43) Pub. Date: Jan. 20, 2005

(54) Marketing of photopolymeric sleeves for flexographic printing

(75) Inventors: Uwe Stebani, Floersheim-Dalsheim (DE); Hartmut Sandig, Frankenthal (DE); Thomas Telser, Heidelberg (DE); Udo Metzmann, Obrigheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Drucksysteme GmbH, Stuttgart (DE)

(21) Appl. No.: 10/874,278

(22) Filed: Jun. 24, 2004

Related U.S. Application Data
(60) Provisional application No. 60/509,246, filed on Oct. 8, 2003.
(60) Provisional application No. 60/483,631, filed on Jul. 1, 2003.

(51) Int. Cl. G06F 17/60

(52) U.S. Cl. 705/10; 705/1

(57) ABSTRACT

Photopolymeric sleeves for flexographic printing are marketed by a method in which a customer is supplied with a suitable apparatus and necessary know-how for producing photopolymeric sleeves so that said customer is enabled to produce photopolymeric sleeves himself.

The invention relates to a method for marketing photopolymeric sleeves for flexographic printing, in which a customer is supplied with a suitable apparatus and necessary know-how for producing photopolymeric sleeves so that said customer is enabled to produce photopolymeric sleeves themselves.

Flexographic printing plates can be mounted directly on the printing cylinder of the printing press for printing. For a four-color printer, four flexographic plates must be mounted on four different printing cylinders and aligned in register. This is relatively complicated and expensive because printing cannot be carried out with the press during this time.

It is therefore also known that sleeves can be used for flexographic printing. A sleeve is a cylindrical hollow body on whose outer surface a printing layer has been applied. The sleeve technique is particularly important for continuous printing plates, i.e. printing plates in which the outer surface of the cylindrical hollow body has been completely provided with a printing layer surrounding said body. Such printing plates are very important for printing continuous patterns and are used, for example, for printing wallpapers, decorative papers or gift wrapping papers.

The sleeve technique permits very rapid and simple changing of the printing plate. For the sleeve technology, the printing presses are equipped with special printing cylinders, i.e. air cylinders. The air cylinders have a compressed air connection at the end face, with which compressed air can be passed into the interior of the cylinder. From there, it can emerge again via holes arranged on the outside of the cylinder. For mounting a sleeve, compressed air is passed into the air cylinder and emerges again at the exit holes. The sleeve can now be pushed onto the air cylinder because it expands slightly under the influence of the air cushion, and the air cushion substantially reduces the friction. When the compressed air supply is stopped, the expansion is eliminated and the sleeve rests firmly on the surface of the air cylinder. Further details on the sleeve technique are disclosed, for example, in Technik des Flexodrucks, page 73 et seq., Coating Verlag, St. Gallen, 1999.

In order to obtain a good printed copy, at least two, usually three, companies must cooperate in flexographic printing by means of sleeve technology. The procedure is shown schematically in FIG. 1.

First, a photopolymerizable flexographic printing sleeve must be produced as a starting material. Here, suitable techniques are used to provide the abovementioned cylindrical hollow body with a relief-forming, photopolymerizable layer completely surrounding said body. This step is carried out by a sleeve manufacturer.

The sleeve manufacturer produces the cylindrical hollow body himself or in turn obtains it from a supplier. Techniques for applying a photopolymerizable layer to the cylindrical hollow body are known in principle to a person skilled in the art. Examples include coating from solution, ring extrusion or wrapping the cylindrical hollow body with a solid layer of photopolymerizable material followed by calendering. In this context, reference may be made, for example, to DE 27 22 896, DE 29 11 980, EP-A 469 375 or U.S. Pat. No. 5,916,403.

In a second step, the actual cylindrical printing plate must be produced using the photopolymerizable sleeve, i.e. a printing relief must be produced from the photopolymerizable layer. In the case of flexographic printing plates, the projecting parts of the printing plate are printing and the wells are nonprinting.

There are different techniques for producing the printing relief:

The relief can be produced, for example, by exposing the photopolymerizable sleeve through a mask and thus selectively crosslinking the photopolymerizable layer. The mask may be either a photographic mask or a digitally produced mask. A digital mask may be produced by coating the photopolymerizable layer with an IR-ablatable layer comprising carbon black and a binder and imagewise ablating the layer using an IR-laser.

After the exposure, the partly crosslinked layer is developed using a suitable solvent, i.e. those parts of the layer which are covered by the mask and have thus remained uncrosslinked are removed.

In an alternative technique, the entire photopolymerizable layer can first be completely crosslinked and the relief can then be engraved directly into the crosslinked layer using a laser. By direct laser engraving the relief itself is engraved using a laser while in the case of using IR-ablatable masks only a mask is created using a laser while the relief is made in a conventional manner.

Details of the processing methods are known in principle to a person skilled in the art and are disclosed, for example, in EP-A 767 407, EP-A 871 069 or WO 02/76739.

The printing plates are usually produced in a process engravers, who produce printing plates on behalf of the printer, or directly by the printer. For larger printers with many printing orders, the acquisition of the necessary apparatuses for the production of the printing plates may be economically worthwhile, whereas smaller printers generally tend to order printing plates from a process engraver.

In a third step, printing is finally effected by a printer using the cylindrical printing plates obtained.

However, the logistical effort in the method described above is very great.

The cylindrical hollow bodies described above which serve as a support for the photopolymerizable layer, are very expensive and, depending on size and design, typically cost about $200 to 300 each. Such cylindrical hollow bodies cannot be used only once and then discarded but have to be used several times in order to operate economically. Thus, after completion of a printing order, the printing layer must be removed from the cylindrical hollow body and a fresh photopolymerizable layer applied. For this purpose, the sleeves must be sent by the printer back to the manufacturer.

Furthermore, printing presses are not standardized and accordingly there is very wide range of printing presses with printing cylinders of different length and diameter. Thus, cylindrical hollow bodies having different lengths and diameters are also required. Furthermore, depending on the printing order to be fulfilled, it may be necessary to use cylindrical hollow bodies of different types. There are, for example, hard cylindrical hollow bodies, for example of glass fiber-reinforced plastic, or compressible cylindrical hollow bodies which still have a foam support. Depending on the material on which printing is to be effected, different relief layers are also required, for example relatively thick, soft relief layers or relatively thin, hard relief layers.

A sleeve manufacturer who always wishes to be ready to deliver immediately would accordingly have to stock a very large number of sleeves comprising cylindrical hollow bodies of various dimensions and various types and moreover different types of relief layers.

However, such stock-keeping gives rise to very high costs in view of the wide variety of types. The logistic costs in the case of the conventional procedure are also very high. These high costs have to date prevented more widespread use of the sleeve technology in spite of its basic advantages for flexographic printing.

Furthermore, it must be taken into account that photopolymerizable sleeves cannot be stored indefinitely before being used because some of their properties may deteriorate in the course of time. For example, in the course of the production of the sleeves, it is advisable briefly to preexpose the photopolymerizable layer, for example to UV or UV/VIS radiation, from the back before application of the layer to the cylindrical hollow body. A qualitatively better relief can be obtained as a result. With increasing storage time, however, the effect of such a preexposure from the back disappears again.

In practice, a sleeve manufacturer therefore begins to produce a sleeve in general only on receipt of an order.

Accordingly, the processing of printing orders by means of sleeve technology takes a very long time. When a printer receives a printing order, said printer commissions a process engraver to produce the necessary printing plates. The process engraver orders the photopolymeric sleeves of the desired type for the sleeve manufacturer, who generally first has to produce them. After delivery of the photopolymeric sleeves to the process engraver, the latter produces the printing plates and delivers them to the printer. The entire process may take from 3 to 4 weeks. Where problems have occurred in the production of the printing plate and it is necessary to procure a replacement sleeve, it takes as long again. After completion of the printing order, the sleeve must be sent back to the sleeve manufacturer for reuse.

As an alternative to this inconvenient procedure, it has been proposed to use sleeves which have a support only about 330 μm thick and which is no longer intended for reuse. However, the thin support makes such sleeves mechanically unstable and finally leads to a poorer print. This applies in particular to the transport of the sleeves to the printer. Owing to the thin support, the sleeves can be very easily buckled, with the result that they become completely useless for printing. Such problems lead to a relatively large amount of waste and hence to higher costs.

It is an object of the present invention to provide an improved method for marketing photopolymeric sleeves for flexographic printing, in which the inconvenient logistics are substantially simplified and expensive stock-keeping is avoided, but in which it is nevertheless possible to employ stable cylindrical hollow bodies.

We have found that this object is achieved by a method for marketing photopolymeric sleeves which comprises at least the following steps:
a) supplying a customer with an apparatus for producing photopolymeric sleeves,
b) supplying the customer with know-how for producing photopolymeric sleeves, at least to an extent such that the customer is enabled, with the aid of the apparatus made available according to (a) and suitable photopolymeric materials to carry out the production of photopolymeric sleeves himself.

In a preferred embodiment of the invention, the customer is also supplied with suitable photopolymeric materials and, if required, cylindrical hollow bodies and further aids for carrying out the method.

### LIST OF FIGURES

FIG. 1 Conventional marketing of sleeves

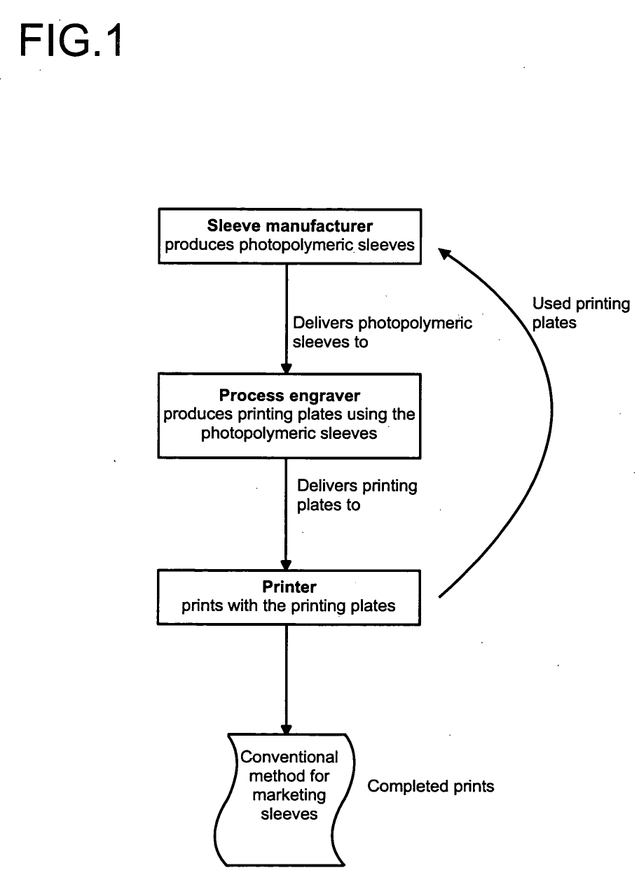

FIG. 2 Marketing of sleeves by the novel method

FIG. 3 Preferred apparatus for applying solid layers of photopolymerizable material

Regarding the invention, the following may be stated specifically:

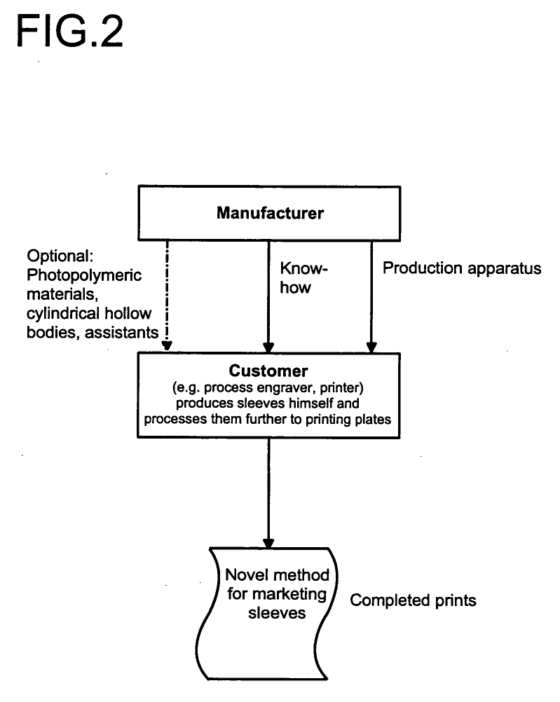

The novel method is shown schematically in FIG. 2. In the novel method for marketing photopolymeric sleeves, the sleeve manufacturer no longer carries out all production steps for the production of photopolymerizable sleeves himself and delivers a prepared, photopolymerizable sleeve but provides the customers with production apparatuses, necessary know-how and optionally also photopolymeric materials, cylindrical hollow bodies and/or other aids for the production of photopolymerizable sleeves. The customers are thus enabled to carry out the final assembly of the photopolymerizable sleeves themselves using the components delivered.

The novel method is preferably used for marketing continuous sleeves and particularly preferably for marketing continuous seamless sleeves without it being intended to restrict the invention thereto. In the case of continuous sleeves, the cylindrical hollow body completely provided with a photopolymeric layer; in the case of continuous seamless sleeves, there is furthermore no seam at all, which might have remained at the abutment point of the layer as a result of wrapping the cylindrical hollow body with a photopolymerizable layer.

The customers may be, for example, printers who wish to manufacture substantially for their own needs. They may also be process engravers who substantially produce printing plates for end users. Mixed forms are of course also conceivable. An example would be a customer who produces on the one hand for his own needs internally in the printing works and on the other hand also produces printing plates for third parties.

According to the invention, a suitable apparatus for producing photopolymeric sleeves is made available by the manufacturer to the customer. In the context of the present invention, made available means that the apparatus can, for example, be sold to the customer but it may also be rented, leased or made available in another way to the customers. The apparatus can be delivered by the manufacturer himself or, at the manufacturer's request, by a third party, for example a manufacturer under contract, licensee or intermediate dealer.

With the aid of the apparatus, a photopolymerizable layer is applied to a suitable cylindrical hollow body by the customer himself.

Cylindrical hollow bodies for the production of sleeves are commercially available. They may consist, for example, of polymeric materials, glass fiber-reinforced polymeric materials or metals. They may be hard cylindrical hollow bodies or compressible cylindrical hollow bodies, i.e. those having a damping support on a hard core. The thickness, diameter and length of the cylindrical hollow body and the material and type thereof are determined by a person skilled in the art according to the desired properties and the desired application of the printing plate.

In a preferred embodiment of the novel method, the cylindrical hollow body is also made available to the customer as a starting material. It may be sold or made available in another way, for example by renting, to the customer. However, the customer can of course also use his own cylindrical hollow bodies or cylindrical hollow bodies from other sources.

Carrying out the novel method is not limited to a certain type of apparatuses. Apparatuses for applying photopolymeric layers to cylindrical hollow bodies are in principle known to a person skilled in the art from the area of sleeve production.

The photopolymerizable material can be applied in principle in solid or in molten form to the cylindrical hollow body. For application in molten form, for example, the apparatus disclosed in U.S. Pat. No. 5,916,403 is suitable. The apparatus which is made available to the customer is, however, preferably an apparatus with which a prefabricated layer of a solid, photopolymerizable material can be applied to the cylindrical hollow body without the photopolymerizable material being melted. Suitable apparatuses for applying solid layers of photopolymerizable material are disclosed, for example, in DE-A 29 11 980.

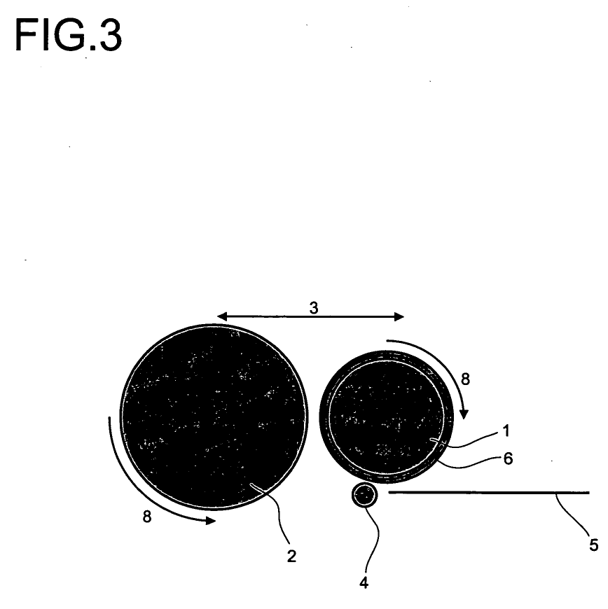

A preferred apparatus for applying solid photopolymerizable material to the cylinder is shown schematically in FIG. 3.

The apparatus has an air cylinder (1) and a heatable calender roll (2). Both cylinders are rotatably mounted. For the sake of clarity, the suspensions of the cylinders are not shown. At least one of the two rolls is moreover mounted so as to be displaceable in the horizontal direction so that the rolls can be moved toward one another and apart. This is shown schematically by the double headed arrow (3). For heating, for example, electrical heating elements can be installed in the calender roll or hot oil can flow through the roll. An auxiliary roll (4) whose distance relative to the air cylinder can be set is also provided as an aid for mounting. The auxiliary roll (4) is preferably arranged below the air cylinder. The auxiliary roll is preferably a rubber roll. The apparatus furthermore has a feed apparatus (5) for the photopolymerizable layer and/or an additional adhesive film. The feed apparatus may simply be, for example, an assembly table on which the photopolymeric layer and/or the adhesive film can be placed and can be pushed uniformly into the gap between cylindrical hollow body and auxiliary roller from there. This can be effected manually, preferably by means of a suitable pushing apparatus. The calender roll should have very little adhesion to the photopolymerizable layer. For example, it may be polished or have a nontacky coating, for example a Teflon coating. The apparatus can of course also comprise further assemblies.

The operation of the apparatus is explained by way of example below without there being any intention at all thereby to restrict the invention to this mode of operation or to the use of the apparatus. For carrying out the process, a cylindrical hollow body (6) is first pushed onto the air cylinder (1). Thereafter, an adhesive film provided with an protective film may be cut to size on the assembly table (5), the air cylinder is caused to rotate and the film may be slowly pushed into the gap between auxiliary roll (4) and the air cylinder (1) provided with the cylindrical hollow body (6). As a result of the rotation, the adhesive film is drawn in, the auxiliary roll pressing the film onto the cylindrical hollow body so that the adhesive film firmly bonds without bubbles to said body. The protective film is then peeled off from the adhesive film. In the next step, a sheet of photopolymerizable material cut to size is pushed into the gap, transported, and firmly pressed by the auxiliary roll (4). The underside of the photopolymerizable layer, which may have been preexposed, is oriented towards the cylindrical hollow body. If the photopolymerizable layer has a protective sheet on the underside this is peeled off beforehand. After the protective sheet on the upper side has been peeled off, the calender roll and the air cylinder provided with the cylindrical hollow body, adhesion-promoting layer and photopolymerizable layer are brought into contact with one another and caused to rotate, and the gap is closed by calendering with the hot calender roll. The preferred direction of rotation during calendering is (8).

More details about the apparatus and its function are disclosed in our previously unpublished application DE 103 18 042.7.

The apparatus can be adapted by the manufacturer, preferably according to the specific requirements of the customers. For example, depending on the printing presses used by the customer, the apparatus can be provided for producing sleeves having a certain diameter and a certain length.

In a manner known in principle, the photopolymerizable materials comprise binders, monomers, photoinitiator and, if required, further additives and assistants, for example plasticizers, dyes or thermal inhibitors. Photopolymerizable materials for producing flexographic printing elements are known in principle to a person skilled in the art. A solid, photopolymerizable layer comprises, as a rule, a flexible support, for example consisting of a thin PET film, on which the photopolymerizable material is applied. The layer together with the support can be applied to the cylindrical hollow body. Preferably, however, the support is removed and the layer without a support is applied to the cylindrical hollow body. For better adhesion, the cylindrical hollow body is preferably provided with an adhesion-promoting layer, for example double-sided self adhesive tape, before application of the photopolymerizable layer, in a manner known in principle. The thickness and the composition of the photopolymerizable layer depends on the use of the prepared printing plates and are chosen accordingly by a person skilled in the art.

In a preferred embodiment of the invention, the manufacturer supplies the customer also with suitable photopolymeric materials for processing in the apparatus. However, the customer can in principle also use photopolymeric materials from other sources, provided that they are suitable for processing in the apparatus.

The same applies for further aids or assistants which are also offered to the customer in a preferred embodiment by the manufacturer, although the customer may also obtain them from other sources. Aids include, for example, self adhesive tapes or materials for producing adhesion-promoting layers which are required for applying the photopolymeric layer to the cylindrical hollow body. They may also be edge sealing materials or cutting apparatuses which may be required for cutting the photopolymeric layer to size before the application.

Particularly preferably, all materials required for production, at least including cylindrical hollow bodies, photopolymeric materials and aids or assistants are offered to the customer by the manufacturer. By offering cylindrical hollow bodies of different types and photopolymerizable materials of different types, the customer can appropriately select the combination preferred for a specific application. All materials and the apparatus are tailored to one another to such an extent that the customer can carry out the processing as a rule by specified routine methods.

According to the invention, the customer is furthermore supplied by the manufacturer with the necessary know-how, at least to an extent such that the customer is enabled, with the aid of the apparatus made available and suitable photopolymeric materials, to carry out the production of photopolymeric sleeves himself.

The know-how comprises at least the operating instructions for the apparatus and a method for producing photopolymerizable sleeves using the apparatus made available. Preferably, the know-how also comprises the specifications for the starting materials to be used and information on the quality control of the prepared photopolymerizable sleeves.

In a preferred embodiment of the novel method, the customer is also offered a consultancy service by the manufacturer. This is intended to provide support for the customer in the event of problems with or queries about the method. The consultancy service may be offered, for example, as a telephone hotline, or queries can be accepted and answered by e-mail, fax or in writing. The consultancy service can also be offered over the Internet and the customer can be provided with information about the method freely or with password protection. Of course, the consultancy service may also comprise supporting the customer by means of the manufacturer's sales employees. This is usually advisable particularly during the commissioning of the apparatus.

As in the case of sleeves supplied by the manufacturer, the photopolymerizable sleeves produced by the customer himself can be further processed in a known manner to give finished printing plates. The further processing can be effected, for example, using a photographic mask, by means of a digital mask, for example an IR-ablative mask, or by means of direct laser engraving as described above.

Finally, the finished cylindrical flexographic printing plates are used for printing. The printing process is performed in a conventional manner by mounting the cylindrical flexographic printing plate on a flexographic printing machine as described above and using conventional flexographic printing inks and substrates to be printed on.

After completion of the printing order, the printing layer can be removed again from the cylindrical hollow body and the latter can be reused.

The present invention also relates to a method of printing using a cylindrical flexographic printing plates at least comprising the steps (A) of making a photopolymeric sleeve, (B) further processing the photopolymeric sleeve to make a finished cylindrical flexographic printing plate, and (C) printing with said cylindrical flexographic printing plate using a printing machine, printing ink and a substrate to be printed on. Examples for suitable substrates include as paper or cardboard. In the method according to the invention at least steps (A) and (B) are done by the customers of a manufacturer of photopolymeric materials for flexographic printing using at least an apparatus for producing photopolymeric sleeves and know-how made available by the manufacturer. In another embodiment of the invention the steps (A), (B), and (C) are performed by the customer.

The novel marketing method has the major advantage that unnecessary logistical effort is avoided. Sleeves, printing plates and cylindrical hollow bodies no longer need be sent back and forth between manufacturer and process engraver or printer. If the customer is a printer, transports are completely dispensed with; if the customer is a process engraver, at least the transports between the manufacturer and process engraver are dispensed with. The manufacturer furthermore avoids expensive stock-keeping of the sleeves of different types. Production can be carried out directly on demand without having to take into account delivery times of sleeve manufacturers. Thus, printing plates can be produced substantially more quickly on demand. By shortening the logistics chain, the quality of the printing plates is also improved. Immediately after production, the sleeves can be further processed to give the printing plate. Changes in the properties due to storage are avoided. If exposure from the back was carried out, its effect is substantially retained.

1. A method for marketing photopolymeric sleeves, at least comprising a cylindrical hollow body and a photopolymerizable layer, at least comprising an elastomeric binder, polymerizable monomers and a photoinitiator, applied thereon, the method comprising at least the following steps:
a) supplying a customer with an apparatus for producing photopolymeric sleeves,
b) supplying the customer with know-how for producing photopolymeric sleeves, at least to an extent such that the customer is enabled, with the aid of the apparatus made available according to (a) and suitable photopolymeric materials, to carry out the production of photopolymeric sleeves himself.

2. A method as claimed in claim 1, wherein the customers are also supplied with photopolymeric materials suitable for processing in the apparatus.

3. A method as claimed in claim 1, wherein the customers are also supplied with cylindrical hollow bodies for producing sleeves.

4. A method as claimed in claim 1, wherein the customers are also provided with aids for producing sleeves.

5. A method as claimed in claim 1, wherein a consultancy service is furthermore made available to the customer.

6. A method as claimed in claim 1, wherein the apparatus comprises at least a rotatable air cylinder (1), a rotatable, heatable calender roll (2), a rotatable auxiliary roll (4) and a feed apparatus (5), the distances between the air cylinder and the calender roll on the one hand and the auxiliary roll and the air cylinder on the other hand being adjustable by suitable means.

7. Photopolymeric sleeve obtainable by a method according to any one of claims 1 to 6.

8. Method of printing using a cylindrical flexographic printing plate at least comprising the steps of
(A) making a photopolymeric sleeve,
(B) further processing the photopolymeric sleeve to make a finished cylindrical flexographic printing plate, and
(C) printing with said cylindrical flexographic printing plate using a printing machine, printing ink and a substrate to be printed on,
whereby at least steps (A) and (B) are done by the customers of a manufacturer of photopolymeric materials for flexographic printing using at least an apparatus for producing photopolymeric sleeves and know-how, both made available by the manufacturer.
